(19) United States
(12) Patent Application Publication
(10) Pub. No.: US 2022/0138519 A1
(43) Pub. Date: May 5, 2022

(54) METHOD AND DEVICE FOR THE CONTROL AND MANAGEMENT OF THE PRINTING PARAMETERS OF A PRINTING MACHINE, PARTICULARLY WITH A PLURALITY OF CONSECUTIVE PRINTING PROCESSES

(71) Applicant: BOBST FIRENZE S.R.L., CAMPI BISENZIO FI (IT)

(72) Inventors: Federico D'ANNUNZIO, Cislago (IT); Matteo CARDINOTTI, Lucca (IT)

(73) Assignee: BOBST FIRENZE S.R.L., CAMPI BISENZIO FI (IT)

(21) Appl. No.: 17/579,018

(22) Filed: Jan. 19, 2022

Related U.S. Application Data
(63) Continuation of application No. 13/985,610, filed on Oct. 24, 2013, now abandoned.

(30) Foreign Application Priority Data
Feb. 17, 2011 (IT) MI2011A000232

(51) Int. Cl. G06K 15/00; B41F 33/00

(52) U.S. Cl. CPC G06K 15/408; B41F 33/0081; B41P 2233/51; B41P 2233/52; B41F 33/0036

(57) ABSTRACT

A device and method for the control and management of the printing parameters of a printing machine, particularly with a plurality of consecutive printing processes, is presented. The device and method include at least one video camera associable with a printing and conversion assembly and movable along a motorized guide in order to acquire a print medium. An image processor is functionally associated with the video camera to search, recognize and measure on the image of the print medium acquired by the video camera the printing values of at least one reference register mark reproduced on the print medium. The image processor is functionally connected to a unit for the actuation of the printing and conversion assembly to correct and restabilize the printing values according to the difference between the printing values measured by the image processor and the desired theoretical printing values.

### CROSS-REFERENCE TO RELATED APPLICATIONS

This application is a continuation of a U.S. application Ser. No. 13/985,610, filed on Aug. 15, 2013, and having a § 371(c) date of Oct. 24, 2013, which is the U.S. national phase of international Application No. PCT/EP2012/050333 filed on Jan. 11, 2012, which claims priority to Italian Patent Application No. MI2011A000232 filed on Feb. 17, 2011, the disclosures of which are incorporated in their entirety by reference herein.

The present invention relates to a method and a device for the control and management of the printing parameters of a printing machine, particularly with a plurality of consecutive printing processes.

In the sector of printing machines, register control systems are known which use control photocells after each printing assembly.

Such photocells are effective in checking the print register, but they cannot be used for checking the pressure and print density because they follow an on-off logic. Moreover, such photocells force the operator to position them manually on the register mark at each change of work and for each printing and conversion assembly.

The photocells must also often be adjusted based on the print medium, on the reading color and on many other variables.

All these adjustment operations often lead the operator to not use such photocells because of the long startup time, which in any case necessitates a major and specialist intervention from the operator.

Also known are systems for detecting the density which use special in-line density sensors which however cannot be used for the register and pressure functions.

Owing to high costs, they are very rarely used on each printing assembly, but only at the end of the printing machine.

Even if they were used on each printing assembly, they would still be difficult to adjust and they would require considerable technical skills to manage them.

Finally, video cameras for end of line visual inspection are known that, among several different functions, can perform the detection of the pressure, the register and the density with a low level of accuracy.

Such video cameras, owing to their large size (which forces a complete redesign of the print and conversion assemblies), owing to the technology used (inspection of the entire printed matter, not focused on the register mark), and owing to their extremely high cost due to their original purpose (inspection of print quality, at 100%), make it impossible to justify their use from both an economical and functional point of view.

More exactly, the use of a video camera for the final inspection of the entire printed matter in order to perform the automatic checking of the register/pressure/density functions defeats the purpose of the checking and intervention function required, since this is performed only at the end of all the print and conversion processes.

For each correction of register, pressure or density it is necessary to wait for an entire length of print medium along all of the machine before evaluating its effectiveness, with a huge waste of material, moreover without being certain that the conditions have not changed again during the machine transition.

All this renders the intervention for correction useless, and in some cases damaging.

At startup, the end of line configuration is useless if not actually damaging since the operator, by working manually on each printing assembly, and not at the end of the line, is capable of achieving more accurate results, in shorter times and with a lower waste of material. Indeed, the end of line systems are especially used as systems for information collection and quality control of the printed matter, and almost never as systems for automatic intervention on the functions, even though these are an integral part of the system.

Its uselessness and lack of cost effectiveness are acknowledged, particularly if controlled functions overlap (register/pressure/density), particularly at startup, particularly on in-line printing machines, and particularly when printing on non-stable or expensive print media such as, for example, non-supported films, aluminum and laminates.

The aim of the present invention is to devise and provide, respectively, a method and a device for the control and management of the printing parameters of a printing machine, particularly with a plurality of consecutive printing processes, which are capable of overcoming and solving, respectively, the limitations and drawbacks of the known art, by operating autonomously without the intervention of the operator, by handling the function of checking register, pressure and density, and by automatically making all the necessary adjustments, independently of the number of colors or of processes.

Within this aim, an object of the present invention is to devise and provide, respectively, a method and a device for control and management that are capable of offering the widest guarantees of reliability and safety in use.

Another object of the invention consists in providing a control and management device that is easy to implement and economically competitive when compared to the known art.

This aim and these and other objects, which will become better apparent hereinafter, are achieved by a device for the control and management of the printing parameters of a printing machine, particularly with a plurality of consecutive printing processes, characterized in that it comprises at least one video camera associable with a printing and conversion assembly and movable along a motorized guide in order to acquire a print medium, image processing means being further comprised which are functionally associated with said at least one video camera to search, recognize and measure, on the image of said print medium acquired by said at least one video camera, the printing values of at least one reference register mark reproduced on said print medium, said image processing means being functionally connected to means for the actuation of said printing and conversion assembly to correct and restabilize said printing values according to the difference between said printing values measured by said image processing means and the desired theoretical printing values.

Further characteristics and advantages of the invention will become better apparent from the detailed description of a preferred, but not exclusive, embodiment of a method and of a device for the control and management of the printing parameters of a printing machine, particularly with a plurality of consecutive printing processes, illustrated for the purposes of non-limiting example in the accompanying drawings wherein:

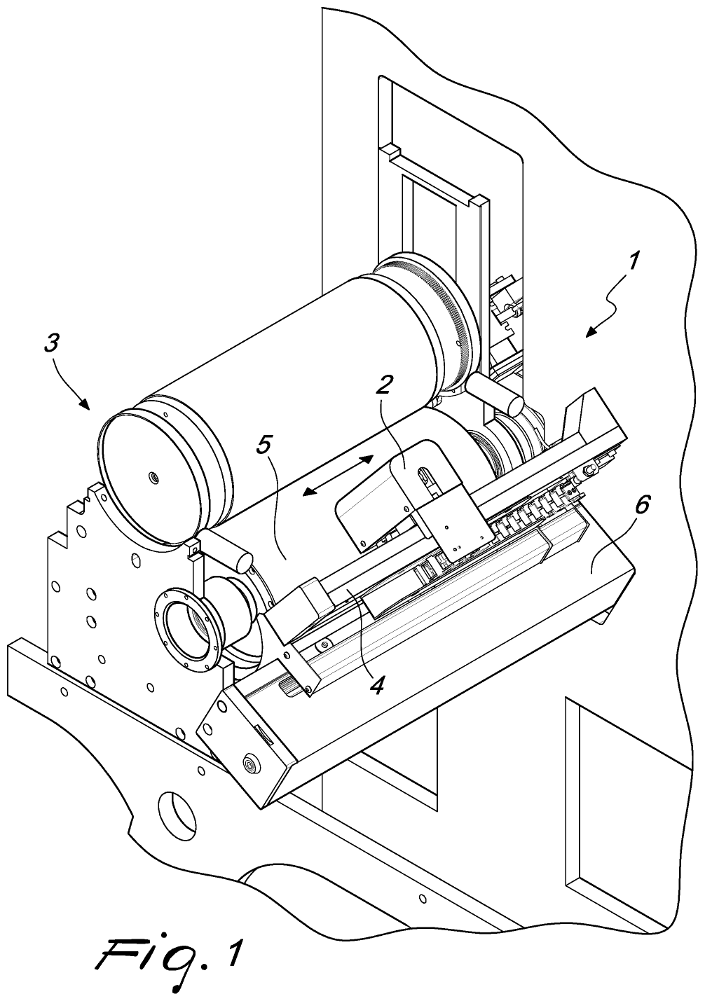

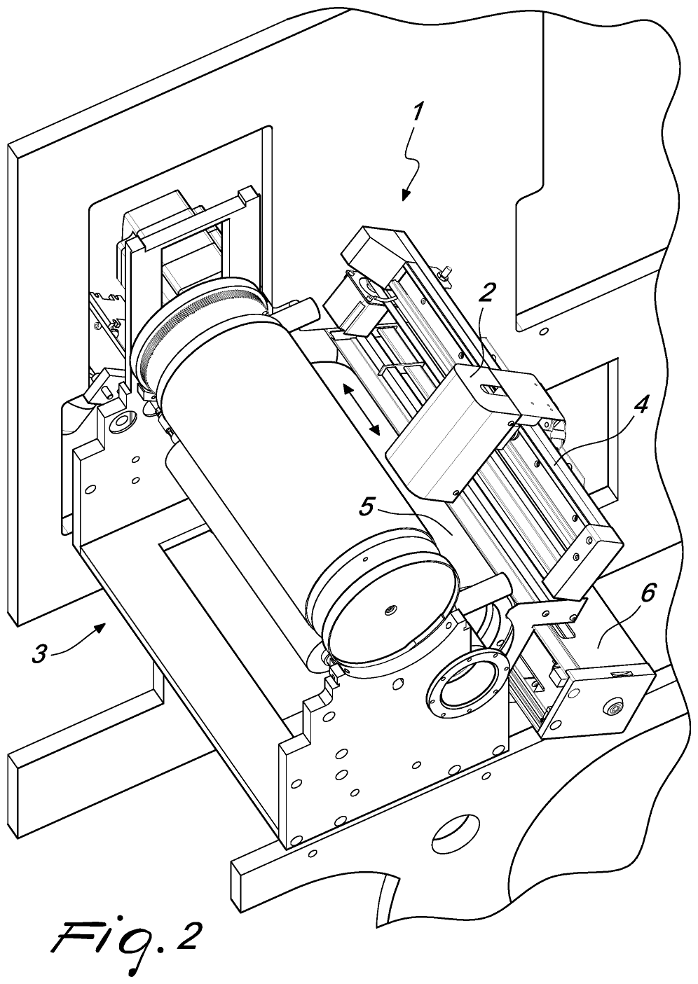

FIGS. 1 and 2 are two perspective views, on from the front and one from the rear, of an embodiment of a device for the control and management of the printing parameters of a printing machine, according to the present invention;

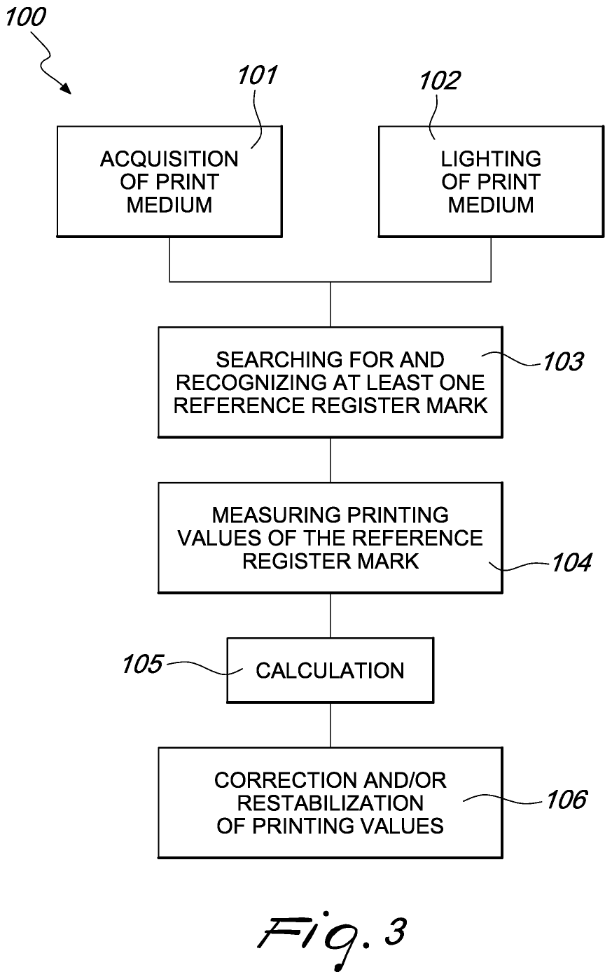

FIG. 3 is a block diagram of a method for the control and management of the printing parameters of a printing machine, according to the present invention.

With reference to the figures, a device for the control and management of the printing parameters of a printing machine, particularly with a plurality of consecutive printing processes, generally designated with the reference numeral 1, comprises at least one video camera 2 associable with a printing and conversion assembly 3 and movable along a motorized guide 4 to acquire a print medium 5.

Advantageously, in order to have an optimal acquisition the video camera 2 can for example have a minimum resolution of 400×400 pixels per square centimeter and is arrangeable at a maximum distance of for example 50 mm from the printing and conversion assembly 3 so as to obtain a viewing field or inspection field of maximum size, for example of 16×12 mm.

Moreover, in order to have an adequate illumination of the viewing field of the video camera 2, lighting means 6 are provided that comprise ultraviolet ray lamps and are adapted to generate a constant and diffuse light over all of the exposure time.

Moreover, in order to automate the device 1, image processing means are provided which are functionally associated with the video camera 2 to search, recognize and measure on the image of the print medium 5 acquired by the video camera 2 the printing values of at least one reference register mark reproduced on the print medium 5.

More specifically, the image processing means are functionally connected to means for the actuation of the printing and conversion assembly 3, which are constituted by micro-servo drives, to correct and restabilize the printing values according to the difference between the printing values measured by the image processing means and the desired theoretical printing values.

The method for the control and management of the printing parameters of a printing machine, particularly with a plurality of consecutive printing processes, generally designated with the reference numeral 100 in the block diagram in FIG. 3, which can be provided with the device 1, comprises the following steps.

The first step 101 consists in the acquisition of a print medium 5 by means of the video camera 2, which is of the type with high resolution with a reduced inspection area and which due to its minimal size can be placed after each printing and conversion assembly 3 on the motorized guide 4, which enables it to move laterally over the print medium 5, according to preset reading cycles.

In parallel with the first step 101, there is a second step 102 that consists in lighting the viewing field of the video camera 2 with a constant and diffuse light by way of the lighting means 6 over the whole exposure time.

Subsequently, there is a third step 103 that consists in searching for and recognizing, by way of the image processing means, in the image of the print medium 5 acquired by the video camera 2, at least one reference register mark which is reproduced on the print medium 5.

The image processing means are responsible for a fourth step 104 which consists in measuring on the image of the print medium 5 acquired by the video camera 2 the printing values of the reference register mark reproduced on the print medium 5.

Subsequently, the fifth step 105 consists in calculating, by means of a CPU (Central Processing Unit) which can be integrated in the image processing means, the difference between the printing values measured by the image processing means and the desired theoretical printing values.

More exactly, the image processing means search for and recognize on the print medium 5 one or more specially printed reference marks, and measure their values of density, pressure and print register, comparing them with previously specified tolerances, and sending this information to the CPU which processes the data received.

Finally, the final step 106 consists in correcting and/or restabilizing the printing values by means of the intervention of the CPU of the image processing means, using specially developed algorithms, on the means for the actuation of the printing and conversion assembly 5 according to the calculated difference.

To sum up, the video camera 2, thanks to the reduced inspection surface, to the very high resolution, to the lighting means 6 and to the great internal processing capacity, is capable of detecting the following data.

First of all the print register is detected: the video camera 2 recognizes, by inspecting the printed matter and autonomously, the register mark printed by the process head, verifies the position of the mark with respect to a reference mark printed previously (master mark), and informs the CPU of the image processing means of any deviation of the mark with respect to the preset position (ideal register position). Finally, the CPU of the image processing means provides for the lateral and longitudinal shifting of the register mark until it reaches the ideal register position.

Secondly, the print pressure is detected: the image processing means recognize the same register mark, and a second one on the other side of the paper, and measures its size (calculated in numbers of pixels), comparing it with a theoretical value in order to establish whether the print pressure exerted on the print medium 5 is insufficient (missing or incomplete print: lower number of pixels) or excessive (excess squashing deformation of the print, and hence a higher number of pixels). It sends the measured values to the CPU which decreases or increases the print pressure on the assembly.

Finally, the density is detected: the video camera 2 again recognizes the same marks used for register and pressure, and the image processing means measure their reflection at a certain incident light having preset characteristics. The quantity and quality of light reflected are a function of the quantity of ink deposited on the specific print medium. The image processing means consequently provide for increasing or decreasing the quantity of ink on the print medium, according to preset values.

Moreover, the image processing means, by means of specially-developed software for identification and thanks to the lighting means 6, recognize every type of ink or even of paint, or even punching and embossing, and they can recognize register marks produced by any method of printing and conversion.

In practice it has been found that the method and the device for the control and management of the printing parameters of a printing machine, particularly with a plurality of consecutive printing processes, according to the present invention, achieve the intended aim and objects in that, by availing of a video camera with very high resolution, of reduced size, with reduced inspection area and dedicated to a unique mark of register/pressure/density on each printing and conversion assembly, at a very short distance from the print and conversion cylinder of each assembly, make it possible to obtain corrections that are automatic, immediate and simultaneous (as well as cumulative) of all the functions, thus achieving the high reduction of waste in the startup step, while at the same time ensuring the preset tolerances and ensuring repeatability and hence the predictability of waste and of print quality (as the sum of the three functions of register/pressure/density).

Moreover, the use of a video camera equipped with a special light enables the reading of special marks such as punching, embossing, paints, etc., which are impossible to read with other reading systems, thus making the invention particularly advantageous for controlling printing machines with a plurality of processes, in which all print quality adjustment is entrusted to the control system, independently of the number of colors and of processes used.

Another advantage of the method and of the device, according to the present invention, consists in that it uses the same reading mark for the print register, the pressure and the density, thus making recognition thereof immediate, and the numeric density value is immediately and easily read (a simple alphanumeric data item, independent of color, process etc.).

A further advantage of the method and of the device, according to the present invention, consists in that it makes all the adjustments that determine the print quality “digital”, since they are measurable. The required tolerances, and hence the quality, are automatically ensured, both in the startup step and in the production step. In the same way it is possible to accurately predict the already low startup costs (time and waste) and the high production speeds, linked to mathematical formulas and algorithms. The operator can therefore concentrate on achieving the best productivity and the highest print quality, relying on the support of the universal and economic control system.

The method and the device for the control and management of the printing parameters of a printing machine, particularly with a plurality of consecutive printing processes, thus conceived, are susceptible of numerous modifications and variations, all of which are within the scope of the appended claims.

Moreover, all the details may be substituted by other, technically equivalent elements.

In practice the materials employed, provided they are compatible with the specific use, and the contingent dimensions and shapes, may be any according to requirements.

The disclosures in Italian Patent Application No. MI2011A000232 from which this application claims priority are incorporated herein by reference.

What is claimed is:

1. A device for control of plurality of consecutive printing assemblies, the device comprising:
a plurality of cameras positioned consecutively, one camera positioned after each one of the plurality of printing assemblies to acquire an image of a printed medium after each printing process;
an image processor in communication with the plurality of cameras and programmed to:
recognize a register mark within the image of the printed medium; and
measure a measured pixel quantity of the register mark;
an actuator connected each of the consecutive printing assemblies; and
a controller in communication with the image processor and the actuator to provide feedback control of each of the plurality of consecutive printing assemblies and programmed to:
calculate a printing pressure based on the difference between the measured pixel quantity and a desired pixel quantity;
command the actuator to automatically correct a future printing pressure based on the difference between the measured pixel quantity and a desired pixel quantity,
wherein the each of the plurality of consecutive printing assemblies are configured to be corrected independently by the actuator.

2. The device to claim 1 wherein the actuator comprises a plurality of a micro-servo drives, wherein one micro-servo drive is connected to one of each of the consecutive printing assemblies to automatically correct the future printing pressure without intervention by an operator.

3. The device of claim 1 wherein the controller is further programmed to:
decrease the future printing pressure if the measured pixel quantity is greater than the desired pixel quantity; and
increase the future printing pressure if the measured pixel quantity less than the desired pixel quantity.

4. The device of claim 1, wherein the image processor is further programmed to measure a printed position of the register mark; and
the controller is further programmed to command the actuator to automatically correct a future printing position based on the difference between the measured printed position and a desired printed position.

5. The device of claim 4, wherein the controller is further programmed to shift the future printed position in at least one of a lateral and longitudinal direction.

6. The device of claim 1, wherein the image processor is further programmed to measure a printed density of the register mark based on a measured quantity of reflected light from a light source, and
wherein the controller is further programmed to command the actuator to automatically correct a future printing density based on the difference between the measured quantity of reflected light and desired reflected light quantity.

7. The device of claim 6 wherein the light source comprises an ultraviolet ray lamp adapted to generate a constant and diffuse light throughout an exposure time.

8. The device of claim 6 wherein the controller is further programmed to adjust a quantity of ink if the measured quantity of reflected light based on the difference between the measured quantity of reflected light and desired reflected light quantity.

9. A method for the control of a plurality of consecutive printing assemblies, the method comprising:
acquiring an image of a printed medium after each one of the plurality of consecutive printing assemblies;
recognizing a register mark within the image of the printed medium;
measuring a measured pixel quantity of the register mark;
correcting a future printing pressure based on the difference between the measured pixel quantity and a desired pixel quantity.

10. The method of claim 9 further comprising commanding an actuator connected to each consecutive printing assembly to automatically correct the future printing pressure without intervention by an operator.

11. The method of claim 9 wherein correcting the future printing pressure comprises:
decreasing the future printing pressure if the measured pixel quantity is greater than the desired pixel quantity; and
increasing the future printing pressure if the measure pixel quantity less than the desired pixel quantity.

12. The method of claim 9 further comprising:
measuring a printed position of the register mark; and
correcting a future printing position based on the difference between the measured printed position and a desired printed position.

13. The method of claim 12 wherein correcting the future printing position comprises:
shifting the future print position in at least one of a lateral and longitudinal direction.

14. The method of claim 9 further comprising:
measuring a printed density of the register mark based on a measured quantity of reflected light from a light source;
correcting a future printing density based on the difference between the measured quantity of reflected light and desired reflected light quantity.

15. The method of claim 14 further comprising:
adjusting a quantity of ink if the measured quantity of reflected light based on the difference between the measured quantity of reflected light and desired reflected light quantity.

16. The method of claim 14, further comprising illuminating the printed medium with the light source having constant and diffuse light.

17. A printing machine comprising:
a plurality of consecutive printing assemblies each processing a print medium with one of a plurality of consecutive printing process;
a plurality of cameras positioned consecutively, one camera positioned after each of the plurality of consecutive printing assemblies to acquire an image of a printed medium after each printing process; and
an image processor in communication with the plurality of cameras and programmed to:
recognize a register mark within the image of the printed medium;
measure a size of the register mark based on a measured pixels quantity of the register mark;
a controller in communication with the image processor and each of the plurality of consecutive printing assemblies, the controller programmed to:
correct a future printing pressure based on the difference between the measured pixel quantity and a desired pixel quantity,
wherein each of the plurality of assemblies is adjustable independently to correct at least one of the plurality of consecutive printing processes before all of the plurality of consecutive printing processes are complete.

18. The printing machine of claim 17 further comprising an actuator connected each of the consecutive printing assemblies and in communication with the controller, wherein the controller commands the actuator to automatically correct the future printing pressure without intervention by an operator.
